(19) United States
(12) Patent Application Publication
(10) Pub. No.: US 2011/0056623 A1
(43) Pub. Date: Mar. 10, 2011

(54) LAMINATION METHOD OF ADHESIVE TAPE AND LEAD FRAME

(75) Inventors: Min-Ho IM, Seoul (KR); Sung-Hwan Choi, Seoul (KR); Chang-Hoon Sim, Seoul (KR); Ki-Jeong Moon, Seoul (KR); Hae-Sang Jeon, Seoul (KR)

(73) Assignee: Toray Saehan, Inc., Gyeongsangbuk-do (KR)

(21) Appl. No.: 12/615,456

(22) Filed: Nov. 10, 2009

(30) Foreign Application Priority Data
Sep. 7, 2009 (KR) 10-2009-0083816

(51) Int. Cl. B29C 65/02

(52) U.S. Cl. 156/275.5

(57) ABSTRACT

This disclosure provides a method for laminating an adhesive tape and a lead frame, more specifically to reduce the warpage of a lead frame after heated lamination in which an adhesive tape for manufacturing semiconductor devices is attached to the lead frame, satisfying all the properties required for lamination, and avoiding adhesive residues from adhesive tapes and the leakage of a sealing resin. A method for laminating an adhesive tape and a lead frame comprises laminating an adhesive tape and a lead, wherein the lamination temperature of an adhesive tape surface and that of a lead frame surface are different from each other, for example, wherein the lamination temperature of the lead frame surface is lower than that of the adhesive tape surface by about 1 to about 200° C.

### CROSS-REFERENCE TO RELATED APPLICATIONS

This application claims the benefit and priority to Korean Patent Application No. 10-2009-0083816, filed Sep. 7, 2009. The entire disclosure of the application identified in this paragraph is incorporated herein by reference.

### FIELD

The present disclosure generally relates to a method for laminating an adhesive tape and a lead frame, and more specifically to a method for laminating an adhesive tape and a lead frame that can reduce the warpage of a lead frame after heated lamination in which an adhesive tape is attached to the lead frame, satisfying the properties required for the lamination process, and avoiding adhesive residues from adhesive tapes and leakage of a sealing resin.

### BACKGROUND

As portable gadgets such as, for example, cell phones, laptop computers, digital video disc (DVD) players, compact disk (CD) players, MP3 players, personal data assistant (PDA) devices, are used more and more in modern life, it becomes necessary to make such products smaller and lighter. Accordingly, it has become a top priority to make semiconductor packages used for such portable electronic gadgets smaller and thinner. Conventional semiconductors have used surface mount packaging techniques such as a gull-wing SO format or a quad-flat-package (QFP) in which leads protruding from the package connect to a circuit board; however, this kind of method is limited by the above-mentioned requirements. In particular, portable communication terminals which make use of frequencies at or above several GHz have lowered performance and efficiency due to the heat generated by dielectric loss of semiconductors.

Recently, the increased demand for a QFN package type indicates that QFN meets the requirements for semiconductors used in small gadgets. For the QFN package type, the package can be directly soldered onto a circuit board because leads do not stick out and are exposed to the bottom thereof, forming lands around a die. Thus, the QFN package type can be made much smaller and thinner than the package type having leads protruding therefrom, reducing the required area on a circuit board by about 40% compared to conventional techniques. The QFN package also has excellent heat dissipation, since the lead frame is on the bottom of the package and, thus, the die pad is directly exposed to the outside, This construction is different from conventional packages having leads on which chips are encapsulated by sealing resin. Accordingly, the QFN type has excellent electrical properties compared to conventional packages with protruding leads. Moreover, QFN has a self-inductance of about one-half that of conventional packages.

When an interface is created on the bottom of the package between the lead frame and sealing resin surface, the sealing resin can easily infiltrate between the lead frame and a molding frame when a typical metal molding frame is used, thereby contaminating the surfaces of the land part or the die pad with the resin. Therefore, it is necessary to first laminate an adhesive tape onto the lead frame and then subject it to a QFN manufacturing and a resin-sealing in order to prevent flashing or bleeding-out of the sealing resin during resin-sealing.

In general, a semiconductor device manufacturing process comprises a tape lamination for bonding an adhesive tape onto one side of a lead frame, a die-attaching process for attaching a semiconductor element onto a die pad of the lead frame, a wire-bonding process for electrically connecting the semiconductor element to the land part of the lead frame, an EMC-molding process for sealing the wire-bonded lead frame using a sealing resin inside a molding frame after the die attaching process, and a detaping process for peeling the adhesive tape for the semiconductor off the sealed lead frame.

A laminator can be used to bond the adhesive tape onto the lead frame of a copper or pre-plated frame (PPF) during the tape lamination process, and the required properties of the adhesive tape can vary depending on the kinds and methods of laminators. There are different methods of pressing that can be used, such as, for example, a roller, a hot press, a roller in combination with a hot press, or wherein only a dam bar of the lead frame is pressed. Depending on the method used, it may be necessary for the adhesive layer to attach well on the lead frame, and to maintain an adhesive strength so as not delaminate the adhesive tape during the handling of the lead frame which has an adhesive tape laminated thereon.

In lamination where a hot press is used, as shown in FIG. 1, heat and pressure are transferred in the process of attaching an adhesive tape 3 onto a lead frame 4, during which the lead frame made of metal in the form of a thin plate goes through thermal expansion and is laminated with the adhesive tape 3. After the lamination, the lead frame assembly 5 with an adhesive tape 3 laminated thereon is cooled down to a room temperature, thereby causing warpage of the lead frame assembly 5, as shown in FIG. 2, due to the difference in thermal expansion or thermal contraction between the lead frame and adhesive tape.

Such warpage causes poor bonding of the semiconductor element onto a die pad in the die attaching process, the next process after lamination process, bringing about poor connection of the wire in wire-bonding and causing leakage of sealing resin during resin-sealing, thereby deteriorating the reliability of semiconductor devices.

In particular, as the thickness and size of the semiconductor packages become smaller and smaller, a lead frame, which is a part of the wiring board for mounting semiconductor chips, also becomes lighter, smaller, and thinner. The above-mentioned warpage becomes more serious in such lighter, smaller and thinner lead frames. Eventually, the warpage of a lead frame becomes larger after lamination, causing deterioration of reliability of the die-attaching process, wire-bonding process, resin-sealing process, and detaping-process, following lamination.

### SUMMARY

The present disclosure provides a method for laminating an adhesive tape and a lead frame in order to reduce the warpage of a lead frame after a heated lamination process in which an adhesive tape for manufacturing semiconductor devices is attached to a lead frame.

The present disclosure also provides a method for laminating an adhesive tape and a lead frame that satisfies all the properties required for the lamination process, and avoids adhesive residues from adhesive tapes and leakage of ealing resin.

The above object is achieved by a method for laminating an adhesive tape and a lead frame, comprising laminating an adhesive tape and a lead frame, wherein the lamination temperature of the adhesive tape surface and that of the lead frame surface are different from each other in the lamination of the lead frame and the adhesive tape.

The lamination temperature of the lead frame surface can be lower than that of the adhesive tape surface.

The lamination temperature of the lead frame surface can be lower than that of the adhesive tape surface by about 1 to about 120° C.

The adhesive tape for manufacturing electronic parts can comprises a heat-resistant substrate and an adhesive layer having an adhesive composition coated on the heat-resistant substrate, wherein the adhesive composition comprises a phenoxy resin, a heat-curing agent, an energy-beam curable acrylic resin and a photo-initiator, and the adhesive layer is cured by heat and energy-beam.

The heat-resistant substrate can have a thickness of about 5 to about 100 μm, a glass transition temperature of about 110 to about 450° C., a thermal expansion coefficient of about 1 to about 35 ppm/° C. at about 100 to about 200° C., and a modulus of elasticity of about 1 to about 10 GPa at 20 to about 25° C.

The adhesive composition can have a glass transition temperature of about 80 to about 150° C.

The phenoxy resin can be a phenoxy resin or a modified phenoxy resin and has a weight average molecular weight of about 1,000 to about 500,000 g/mol.

The adhesive composition can comprise about 5 to about 20 parts by weight of the heat curing agent, about 5 to about 30 parts by weight of the energy-beam curable acrylic resin per 100 parts by weight of the phenoxy resin, and about 0.5 to about 10 parts by weight of the photo-initiator per 100 parts by weight of the energy-beam curable acrylic resin.

Accordingly, the present disclosure provides a reduction of warpage of a lead frame after heated lamination in which an adhesive tape for manufacturing semiconductor devices is attached to a lead frame.

In addition, the present disclosure can also make it possible to laminate an adhesive tape onto a lead frame by enabling the adhesive layer which does not exhibit adhesiveness at room temperature to have adhesiveness during the heated lamination process only, of providing improved heat resistance against the heat to which the adhesive tape is exposed during the semiconductor device manufacturing process by partially forming an interpenetrating network structure through additional photo-curing of the adhesive layer, of improving the reliability of the devices during the semiconductor device manufacturing process, of preventing the leakage of sealing material, and of avoiding adhesive residues on the lead frame or on the sealing material when the adhesive tape is peeled off after the completion of processes.

### DRAWINGS

FIG. 1 is a cross-sectional view of a hot press used for laminating an adhesive tape, especially for manufacturing semiconductors onto a lead frame using a hot press;

FIG. 2 is a cross-sectional view showing the warpage of a lead frame having an adhesive tape for manufacturing semiconductors attached thereon; and

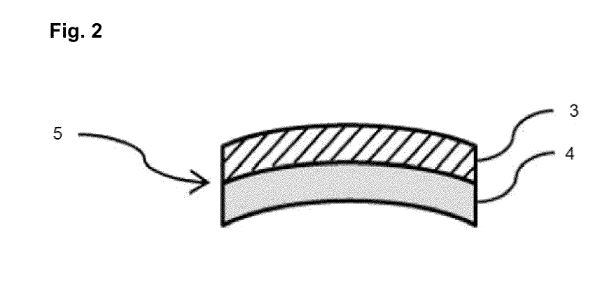

FIG. 3 is a cross-sectional view illustrating a method for measuring the warpage of a lead frame.

### BRIEF DESCRIPTIONS OF DRAWINGS

1a: hot press on the side of an adhesive tape for manufacturing semiconductors
1b: hot press on a lead frame side
2a: surface of an adhesive tape for manufacturing semiconductors
2b: surface of a lead frame
3: adhesive tape for semiconductors
4: lead frame
5: lead frame assembly having an adhesive tape for manufacturing semiconductors attached thereon
6: measurement stand

### DETAILED DESCRIPTION

Hereinafter, embodiments of the present disclosure will be described in detail with reference to the accompanying drawings. It should be understood that the detailed description is given by way of illustration only, and accordingly various changes and modifications within the spirit and scope of the disclosure will become apparent to those skilled in the art.

A method for laminating an adhesive tape and a lead frame comprises laminating a lead frame and an adhesive tape for manufacturing electronic parts. The lamination temperature of the adhesive tape surface and that of the lead frame surface can be different from each other. For example, the temperature of the lead frame surface 2b can be lower than that of the adhesive tape surface 2a in order to reduce the warpage of the lead frame caused by thermal expansion during lamination. In a particular embodiment, the temperature of the lead frame surface lower than that of the adhesive tape surface by about 1 to about 200° C., such as by about 10 to about 120° C.

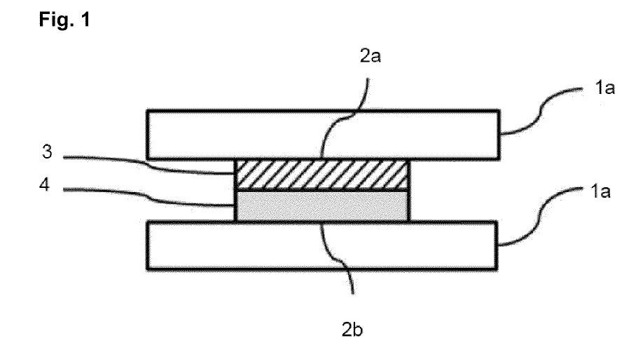

The method for laminating an adhesive tape and a lead frame can use, but is not limited to, laminating an adhesive tape and a lead frame using a hot press in order to manufacture semiconductors, as shown in FIG. 1.

The adhesive tape for manufacturing electronic parts is a necessary component in the semiconductor device manufacturing process. A masking adhesive tape can satisfy the required properties for such a process. In addition, a thermoplastic phenoxy resin with excellent adhesion to metals such, as lead frames, and high heat resistance can be used as a component for an adhesive tape. The adhesive tape prevents bleed-out or flash of a sealing resin because of its excellent cohesion and adhesiveness with the lead frame. The temperature at which the adhesive tape exhibits adhesiveness with the lead frame can be adjusted by varying the degree of curing. Furthermore, adhesive residues left on the lead frame or the sealing resin surface after detaping can be avoided with improved cohesion, for example, by forming additional crosslinks through energy-beam irradiation onto an optionally added photo-curable resin within the adhesive tape.

Moreover, the adhesive tape for manufacturing electronic parts in the present disclosure can be described with reference to the examples of semiconductor packaging process; however, the disclosure is not limited to them and is applicable in other processes, such as mask sheets, in the high temperature manufacturing process of various parts, such as electronic parts.

A polymer film with excellent heat resistance can be used as a substrate, forming an adhesive layer having an adhesive composition coated thereon. Such a heat-resistant substrate can be produced as a film without exhibiting any physical or chemical changes at the above-mentioned temperature range, indicating heat resistance over this time period. Such a heat resistant substrate can have a temperature of at least about 300° C. at which the weight of the substrate decreases by about 5%, and can have a thermal expansion coefficient of about 1 to about 35 ppm/° C. at about 100 to about 200° C. In another embodiment, the substrate can have a glass transition temperature of about 110 to about 450° C. Stable and excellent heat resistance can guarantee a strong wire-bonding property, making it possible to uniformly laminate by keeping the substrate even throughout hot lamination. The size stability of the film at high temperatures helps prevent resin leakage by avoiding deformation of the substrate inside the molding frame during the resin-sealing. In another embodiment, the substrate has a modulus of elasticity of about 1 to about 10 GPa at room temperature (which is typically about 20 to about 25° C.). For example, the substrate can maintain the modulus of elasticity at about 100 to about 5000 MPa at about 100 to about 300° C. If substrates with too low modulus of elasticity are used or if easily foldable substrates are used, creases may form while handling the tape, during the loading of the tape into lamination equipment, or during the feeding of the tape into equipment. The crease and other such defect can cause bad lamination, including partial delamination, non-uniform wire-bonding, and bleeding out of the sealing resin. The substrates that meet the required properties mentioned above can comprise heat-resistant polymer films. Examples of such heat-resistant polymer films include, but are not limited to, films made from heat-resistant polyethylene terephthalate, polyethylene naphthalate, polyphenylene sulfide, polyimide, polyester, polyamide, and polyetherimide.

In some embodiments, the thickness of the substrate film is not limited to a particular value, and can be determined by the application limitations of the lamination equipment and resin sealing equipment. In general, a thickness of about 5 to about 100 μm can be used, such as a thickness of about 10 to about 40 μm. Such a thickness can suppress crease formation due to external forces, maintain appropriate heat resistance, and facilitate film handling. For example, sand mat processing, corona processing, plasma processing, and primer processing can each be applicable in order to improve adhesiveness between the adhesive tape and the substrate film.

The adhesive layer of the adhesive tape for manufacturing electronic parts can comprise a thermoplastic phenoxy resin with good heat resistance and excellent adhesive strength. The phenoxy resin can comprise a photo-curable resin, such as an energy-beam curable resin, for example an energy-beam curable acrylic resin, to preserve heat resistance to adjust the over-curing contraction of the phenoxy resin, a heat-curing agent for the phenoxy resin, and a photo-initiator (for the photo-curable resin).

Examples of such thermoplastic phenoxy resin can include, but is not limited to, bisphenol A-type phenoxy, bisphenol A-type/bisphenol F-type phenoxy, bromine-based phenoxy, phosphorus-based phenoxy, bisphenol A-type/bisphenol S-type phenoxy, or caprolactone-modified phenoxy. In a particular aspect of this embodiment, the phenoxy resin is a bisphenol A-type phenoxy, which can have excellent heat resistance, be environmentally friendly, and be compatible with a curing-agent.

In another aspect of this embodiment, the phenoxy resin can have an average molecular weight of about 1,000 to about 500,000 g/mol. In this weight range, the occurrence of adhesive residues can be minimized during detaping because of improved heat resistance due to increased internal cohesion. If the average molecular weight is less than about 1000 g/mol, the heat resistance cannot be attained because of lowered internal cohesion. If the average molecular weight is greater than about 500,000 g/mol, then workability of the adhesive layer may be lessened by high viscosity, the coated surface may be uneven after coating, and it may be hard to adjust the properties of the adhesive mixture with other additional ingredients.

Examples of organic solvents capable of dissolving the phenoxy resin include, but are not limited to, ketone-based, alcohol-based, glycolic ether-based, and ester-based solvents. Among such examples, cyclohexanone, methylethylketone, benzyl alcohol, diethylene glycol alkyl ether, phenoxy propanol, propylene glycol methyl ether acetate, tetrahydrofuran and N-methylpyrrolidone, for example, can be used alone or in combination. When an organic solvent is used, about 5 to about 40 parts by weight of phenoxy resin can be used, for example about 20 to about 35 parts by weight per 100 parts by weight of the organic solvent. In order to avoid poor coating and to enhance the adhesiveness with a substrate film as needed, aromatic hydrocarbon solvents such as, for example, toluene, xylene, and aromatic 100, or hexane may be added as a thinner. The amount of thinner can be less than about 40% of the amount of the solvent.

In some embodiments, an appropriate cross-linking agent can be added to the above phenoxy resin, and any kind of cross-linking agent or curing-agent can be used as long as they can cure resins that have a hydroxyl group as a functional group. Examples include, but are not limited to, melamine, urea-formaldehyde, isocyanate-functional pre-polymers, phenolic curing agents, and amino-based curing agents. The amount of the heat-curing agent can be about 0.1 to about 40 parts by weight, such as about 5 to about 20 parts by weight per 100 parts by weight of the phenoxy resin. When the cross-linking structure cannot be fully created due to an insufficient amount of the curing agent (for example, less than about 5 parts by weight), the adhesive layer may become too soft, wherein the relative glass transition temperature drops and the loss modulus increases. In this case, the lead frame sticks to the adhesive layer too much during the lamination, and the adhesive is pushed by the lead frame moves up to around the land part or die pad of the lead frame, thereby making the adhesive stick between the lead frame and the sealing resin during resin-sealing and leaving adhesive residues during detaping. If the amount of the curing agent is too great, such as more than about 20 parts by weight, then delamination of the adhesive layer may occur due to too low wettability and adhesiveness, and the adhesive layer can crumble during the lamination due to over-increased adhesive strength. In addition, the tape can warp due to too much curing contraction during drying or curing after the adhesive is coated on the substrate film, thereby resulting in loss of workability.

A resin, such as an energy-beam curable acrylic compound, which creates additional crosslinks onto a cross-linked phenoxy resin can comprise, for example, an acrylic monomer, an acrylic oligomer, or an acrylic polymer having at least one unsaturated bond, such as a carbon-carbon double bond. This acrylic group can form cross-links through a free radical reaction, and the reactivity, crosslinks, and degree of curing can be adjusted by varying the number of such acrylic or crosslinkable groups. As the number of the functional groups increases, the reaction (cross-linking) rate also increases, the glass transition temperature increases, and the heat resistance improves; however, the flexibility and the adhesive strength of the adhesive layer can decrease. When an acrylic resin having an appropriate number of functional groups is selected, it is important to balance between adhesive strength and stiffness, such as when selecting a heat-curing agent for curing the phenoxy resin. Examples of such acrylic compounds used for energy-beam curing can comprise, for example an epoxy acrylate, an aromatic urethane acrylate, an aliphatic urethane acrylate, a polyether acrylate, a polyester acrylate and an acrylic acrylate, and may be used alone in combination. An oligomer can be selected according to the number of the functional groups among various kinds of oligomers. An oligomer with about 2 to about 9 functional groups can be used, such as an oligomer with about 6 to about 9 functional groups, in order to avoid adhesive residues left on the sealing resin surface and the lead frame during detaping, and to have high curing density and a strong wire-bonding property with the increased glass transition temperature, strength, and cohesion of the adhesive layer.

The amount of such energy-beam curable acrylic compound which can be used is about 1 to about 40 parts by weight per 100 parts by weight of the phenoxy resin, such as about 5 to about 30 parts by weight.

In another embodiment, a photo-initiator can be used for initiating the curing of the energy-beam curable acrylic compound by an energy beam and can comprise, but is not limited to, benzophenone-based, thioxanthone-based, alpha hydroxy ketone-based, alpha amino ketone-based, phenyl glyoxylate-based, or acyl phosphine. The photo-initiator can be used alone or in combination, depending on the efficiency and properties of the photo-initiators used to form uniformly crosslinked structure, the thickness of the adhesive layer, or the intensity of the energy-beam. The amount of the photo-initiator can be about 0.5 to about 10 parts by weight per 100 parts by weight of the energy-beam curable acrylic resin, such as about 1 to about 5 parts by weight.

In some embodiments, the adhesive composition of the adhesive tape for manufacturing electronic parts can have a glass transition temperature of about 80 to about 150° C., and the adhesive layer can have an adhesive strength of about 0 to about 1 gf/50 mm at room temperature with respect to stainless steel material (STS). If the glass transition temperature is lower than about 80° C., then the properties of the adhesive at high temperature changes too much with the heat from the QFN process, and if higher than about 150° C., then the lamination temperature of the adhesive tape is over about 170° C., thereby causing more warpage after lamination due to increased difference between the thermal expansion of the lead frame and the thermal expansion of the adhesive tape.

In view of the reasons described above, lamination of the adhesive tape for manufacturing electronic parts can be carried out at about 50 to about 170° C., at which temperature the warpage of the lead frame due to the thermal expansion thereof can be reduced.

Hereinafter, the present disclosure has following examples; however, the invention is not limited to such examples.

### EXAMPLES

### Example 1

First, 100 parts by weight of a phenoxy resin (Kukdo Chemical Co., YP50), which was a main ingredient of an adhesive, was dissolved into 300 parts by weight of a methyl ethyl ketone. Then, 15 parts by weight of an isocyanate-based heat-curing agent (Dow Corning, CE138), 20 parts by weight of an aliphatic polyurethane acrylate (Nippon Synthetic Chemical Industry, UV7600B80), which is an energy-beam curable compound, and 2 parts by weight of an acyl phosphine-based photo-initiator (CYTEC, DAROCUR TPO) were added to the mixture of the phenoxy resin and solvent to prepare an adhesive composition. Thereafter, the adhesive composition was stirred for one hour. After the stirring, the adhesive composition was coated on a polyimide film (LN, by Kolon Co.) of 25 μm and was dried inside a drier at 150° C. for 3 minutes. The thickness of the resulting film was about 6 μm. The dried tape after passing through the drier was subject to an energy-beam curing process for creating an additional crosslinks by ultraviolet irradiation to produce an adhesive tape for manufacturing electronic parts.

### Examples 2 to 5

For Examples 2 to 5, a method for laminating an adhesive tape for manufacturing semiconductors onto a lead frame using a hot press, as shown in FIG. 1, was applied.

Laminations were performed using conventional lead frames and adhesive tapes for manufacturing electronic parts produced according to the above Example 1, by varying the lamination temperature of the lead frame surface and that of the adhesive tape surface as shown in Table 1 below according to each Example.

### Examples 6 and 7 (Comparative Examples)

For Examples 6 and 7, laminations were performed in the same way as Examples 2 to 5, except that the lamination temperature of the lead frame surface and that of the adhesive tape surface in Table 1 were the same.

### Data for Examples 2 to 7

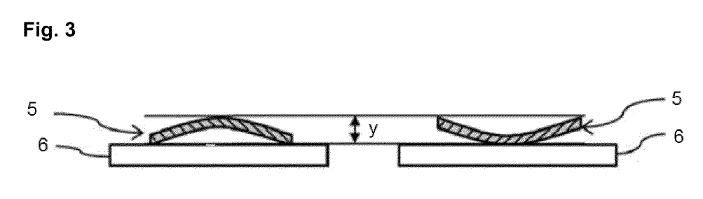

The degree of warpage (y) of the lead frames that have adhesive tape for manufacturing semiconductors produced according to the Examples was measured. The measurement of the degree of warpage was carried out as follows: first, an adhesive tape 3 was attached to a lead frame 4, according to a method shown in FIG. 1; then, the lead frame assembly 5 having the adhesive tape attached thereon was put on a measurement stand 6 as shown in FIG. 3; and the largest distance (y) between the lead frame and the bottom face was measured. The results are shown in Table 1 below.

TABLE 1

| Category | Example 2 | Example 3 | Example 4 | Example 5 | Example 6 | Example 7 |
|---|---|---|---|---|---|---|
| Adhesive tape | 170 | 170 | 170 | 170 | 170 | 170 |
| surface | | | | | | |
| temperature (° C.) | | | | | | |
| Lead frame surface | 50 | 70 | 140 | 160 | 170 | 230 |
| temperature (° C.) | | | | | | |
| Lead frame | 5 | 5 | 5 | 5 | 5 | 5 |
| thickness (mil) | | | | | | |
| Pressure (MPa) | 6 | 6 | 6 | 6 | 6 | 6 |
| Time (s) | 12 | 12 | 12 | 12 | 12 | 12 |
| Warpage (μm) | 410 | 421 | 754 | 1390 | 1410 | 2570 |

As can be seen from the Table 1, the Examples 2 to 5 according to the lamination method of an adhesive tape and a lead frame, wherein the laminations were performed by setting the temperature of the lead frame surface 2b to be lower than that of the adhesive tape surface 2a had less warpage than Example 6, where the lamination was performed by applying the same temperature to the adhesive tape surface 2a and the lead frame surface 2b. Especially, Examples 2 and 3, where the lamination temperature of the adhesive tape surface is lower than that of the lead frame surface by about 100 to about 120° C., exhibited the least warpage. Example 7, where the lamination was performed by setting the lead frame surface 2b temperature to be higher than the adhesive tape surface 2a temperature, exhibited the most warpage of all Examples.

Accordingly, the method of laminating a lead frame and an adhesive tape exhibits less warpage of the lead frame having the adhesive tape attached thereon due to less thermal expansion/contraction of the lead frame from the less application of heat to the lead frame 4.

The disclosure has been described in detail with particular reference to examples and embodiments thereof among various embodiments that had been carried out by the present inventors, but it will be understood that variations and modifications can be effected by those skilled in the art without departing from the spirit and scope of the disclosure.

What is claimed is:

1. A method for laminating an adhesive tape and a lead frame comprising:
laminating an adhesive tape and a lead frame, wherein the lamination temperature of the adhesive tape surface and the lamination temperature of the lead frame surface are different from each other.

2. The method of claim 1, wherein the lamination temperature of the lead frame surface is lower than the lamination temperature of the adhesive tape surface.

3. The method of claim 1, wherein the lamination temperature of the lead frame surface is lower than the lamination temperature of the adhesive tape surface by about 1 to about 200° C.

4. The method of claim 1, wherein the adhesive comprises a heat-resistant substrate and an adhesive layer having an adhesive composition coated on the heat-resistant substrate.

5. The method of claim 4, wherein the adhesive composition comprises a phenoxy resin, a heat-curing agent, an energy-beam curable acrylic resin and a photo-initiator.

6. The method of claim 4, wherein the adhesive layer is cured by heat and energy-beam.

7. The method of claim 1, wherein the adhesive comprises a heat-resistant substrate and an adhesive layer having an adhesive composition coated on the heat-resistant substrate, wherein the adhesive composition comprises a phenoxy resin, a heat-curing agent, an energy-beam curable acrylic resin and a photo-initiator, and wherein the adhesive layer is cured by heat and energy-beam.

8. The method of claim 7, wherein the heat-resistant substrate has a thickness of about 5 to about 10 μm

9. The method of claim 7, wherein the heat-resistant substrate has a glass transition temperature of about 110 to about 450° C.

10. The method of claim 9, wherein the adhesive composition has a glass transition temperature of about 80 to about 150° C.

11. The method of claim 7, wherein the heat-resistant substrate has a thermal expansion coefficient of about 1 to about 35 ppm/° C. at about 100 to about 200° C.

12. The method of claim 7, wherein the heat-resistant substrate has a modulus of elasticity of about 1 to about 10 GPa at about 20 to about 25° C.

13. The method of claim 7, wherein the phenoxy resin is a phenoxy resin or a modified phenoxy resin and has an average molecular weight of about 1,000 to about 500,000 g/mol.

14. The method of claim 7, wherein the adhesive composition comprises about 5 to about 20 parts by weight of the heat-curing agent and about 5 to about 30 parts by weight of the energy-beam curable acrylic resin per 100 parts by weight of the phenoxy resin, and comprises about 0.5 to about 10 parts by weight of the photo-initiator per 100 parts by weight of the energy-beam curable acrylic resin.

15. The method of claim 14, wherein the heat-resistant substrate has a thickness of about 5 to about 10 μm.

16. The method of claim 14, wherein the heat-resistant substrate has a glass transition temperature of about 110 to about 450° C.

17. The method of claim 16, wherein the adhesive composition has a glass transition temperature of about 80 to about 150° C.

18. The method of claim 14, wherein the heat-resistant substrate has a thermal expansion coefficient of about 1 to about 35 ppm/° C. at about 100 to about 200° C.

19. The method of claim 14, wherein the heat-resistant substrate has a modulus of elasticity of about 1 to about 10 GPa at about 20 to about 25° C.

20. The method of claim 14, wherein the phenoxy resin is a phenoxy resin or a modified phenoxy resin and has an average molecular weight of about 1,000 to about 500,000 g/mol.
